(19) United States
(12) Patent Application Publication
(10) Pub. No.: US 2009/0051237 A1
(43) Pub. Date: Feb. 26, 2009

(54) Fastening Device for a Motor in a Household Appliance

(75) Inventor: Andreas Weber, Hennigsdorf (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/086,462

(22) PCT Filed: Nov. 29, 2006
(86) PCT No.: PCT/EP2006/069042

§ 371 Date: Jun. 12, 2008

(30) Foreign Application Priority Data
Dec. 16, 2005 (DE) 10 2005 060 362.9

(51) Int. Cl. H02K 5/22; F16B 21/06

(52) U.S. Cl. 310/91; 411/338

(57) ABSTRACT

A mounting device for a motor used in a household appliance for treating laundry items, which can be a washer and a dryer, the mounting device including at least two connecting members operatively associated with the motor; at least two holding members operatively associated with the household appliance wherein each connecting member is configured for mechanically connecting to a respective holding member; and a latching element for operational association with a connecting member and the respective holding member to maintain at least one mechanical connection between the connecting member and the respective holding member.

The invention relates to a mounting device for a motor in a household appliance for treating laundry items, in particular in a washing machine or tumble dryer.

Mounting devices or retaining units for motors in washing machines are well-known. Thus, for example, DE 689 15 637 T2 describes a retaining unit for an electric motor in a washing machine, which unit is embodied as a two-point motor mounting assembly. With regard to the technical aspects of mounting the motor relative to a transmission, it is critical that the shaft-mounted belt pulley on the motor be kept in a coplanar alignment with the shaft-mounted belt pulley on the transmission assembly. If this relationship does not remain coplanar, the belt will ride off of the belt pulleys and power will not be transmitted from the motor to the transmission. The arrangement of the motor relative to a transmission and in particular with regard to the belt is of central importance in order to be able to ensure optimal operation and optimal transmission of the force generated by the motor via the belt. The motor must therefore be positioned in an optimal location in particular with regard to the belt.

The motor known from the prior art is fixed on a mounting plate and supported with the aid of two mounting ears. The ears are fixed to the mounting plate by means of bolts and nuts attached thereto.

Also known from DE 699 06 851 T2 is a device for mounting the motor on a tub of a washing machine. In one embodiment the plastic tub of the washing machine has two projections into which a pair of ring-shaped projections of the body of the motor can be disposed in relation thereto in such a way that between them there remains a peripheral free space in which plastic sleeves can be disposed. The motor is secured in a hovering position by means of its two ring-shaped projections. A bolt is in turn screwed into the plastic sleeve in order to secure the motor to the tub.

A significant disadvantage with the known mounting arrangements is to be seen in the fact that the fixing by means of bolts is relatively complicated.

It is therefore the object of the present invention to create a mounting device for a motor in a household appliance, which mounting device can be easily implemented and allows mounting with little effort.

This object is achieved by means of a mounting device having the features recited in claim 1.

An inventive mounting device for a motor in a household appliance for treating laundry items is embodied in such a way that the motor has at least two connecting zones and each of said connecting zones is embodied for the purpose of mechanically connecting to a holding zone of the household appliance in each case. At least one mechanical connection between a connecting zone and a holding zone is secured by means of a latching element. A core concept of the invention is that the connection between the motor and the holding zone is able to be secured solely by means of the latching element. By this means a mounting device can be created which is easy to implement and allows a mounting of the motor with little effort. Furthermore, the assembly time can be reduced since there is no longer any need to key in and tighten or remove the bolts used in the prior art.

In an advantageous development of the invention the mounting device comprises a securing element which is embodied as a pin-like insertion element to which the latching element is integrally joined as a single piece. A development of said kind is advantageous since such a securing element can be produced using a small and simple tool while maintaining very narrow tolerances. In this way a virtually play-free latching connection can be ensured between the motor and the holding zone. Furthermore the pin-like insertion elements can be installed quickly and precisely and enable both rapid installation and rapid removal. In addition it is no longer necessary to provide one or more special tools, in particular on the production line, in order to be able to install the bolts used in the prior art.

The pin-like insertion element is advantageously positioned locked in place in its end position. Since the pin-like insertion element is integrally embodied with the latching element, the insertion element can be introduced easily and reliably as a securing element between the connecting zone and a holding zone and fixed in a positionally stable manner in its end position.

In an alternative development of the invention the mounting device comprises at least one pin-like carrier element which is connected to a holding zone and integrally joined to the latching element as a single piece to form a securing element. This enables the latching element to be manufactured together with the carrier element and possibly with the holding device in one production step, with the parts being injection-molded together in a plastic injection mold for example.

The connecting zone of the motor is advantageously positioned locked in place in its end position. In this way the motor can be held in its location in a positionally stable manner.

A securing element will be understood hereinafter to mean both the pin-like insertion element with the connected latching element and the pin-like carrier element connected to the holding zone and integrally joined to the latching element as a single piece. The developments cited below can be applied with totally identical effect to a securing element in the form of either the pin-like insertion element or the pin-like carrier element.

The securing element preferably has a first end zone which is embodied at least conically. Said first end zone is preferably that end zone with which the securing element is initially introduced for the purpose of embodying the mechanical connection between the connecting zone and the holding zone. The securing element is thus inserted with this first end zone in advance or the connecting zone is inserted onto this first end zone of the securing element. Introducing or inserting can be facilitated by the conical embodiment.

The first end zone is advantageously embodied as wider at the end adjoining a middle zone of the securing element than the middle zone. The first end zone preferably has an at least partially circumferential ridge at the end adjoining said middle zone. As a result of such a design of the securing element the latching element is embodied in the region of the first end zone. This enables the insertion element or the connecting zone to lock in place reliably on the carrier element in the end position.

The securing element is advantageously embodied as slotted at least in the area of the first end zone. What can be achieved thereby is that the securing element is embodied as virtually divided into two parts in the first end zone and said two parts of the securing element can be moved relative to each other. On the one hand this enables the introduction of the connecting zone onto the carrier element or, as the case may be, the sliding-in or insertion of the insertion element for the purpose of forming a mechanical connection between the connecting zone and the holding zone to be performed in a simplified manner and with little effort, and on the other hand a secure and reliable locking of the connecting element or, as the case may be, insertion element in the end position can be ensured. In particular when an introduction area in which the securing element, i.e. the insertion element or carrier element, is introduced, has smaller dimensions in diameter as a drilled hole than the securing element in the first end zone, it can thereby be achieved that the end zone can be as it were compressed, and when the end position is reached said two parts automatically return to their original position and move away from each other, thereby enabling a locking in place and secure positioning.

It can also be provided that the first end zone of the securing element is embodied with multiple slots and consequently the securing element has a plurality of part elements, all of which are movable relative to one another, in the area of the first end zone.

The securing element is advantageously embodied as hollow at least over a length between a second end zone and the slotted area. In this case the second end zone is disposed at the end of the middle zone that lies opposite the first end zone. A locking element can advantageously be introduced in the hollow channel of the securing element. Said locking element can be embodied as a securing pin and is preferably longer than the securing element. As a result of introducing a locking element of this kind the securing element can be additionally secured in its end position, since in particular the slotted end zone can be locked in place. The individual parts of the first end zone can be fixed by means of the locking element and a movement of said parts of the first end zone relative to one another can be prevented. This can also prevent the undesirable eventuality that the insertion element may fall out from the end position or the connecting zone may shift on the carrier element.

Each holding zone advantageously has at least one carrier element, in particular mounting studs, the connecting zones of the motor being embodied in such a way that they can be slipped onto the carrier elements. In this arrangement the motor can be very reliably positioned into an optimal position with regard to a belt connected to the motor.

In its installed location the motor is advantageously in a suspended position. Said suspended position or an installed location that can also be referred to as a hovering position allows an arranging and securing of the motor with a reduced number of components. A separate mounting plate is no longer required. The mechanical connection between the connecting zones and the holding zones on its own allows a reliable mounting of the motor. The securing element and/or the locking element can be embodied entirely from plastic or entirely from metal. It can, however, also be provided that at least one of these two elements is embodied at least partially from plastic or at least partially from metal.

The invention is explained in more detail below with reference to schematic drawings, in which:

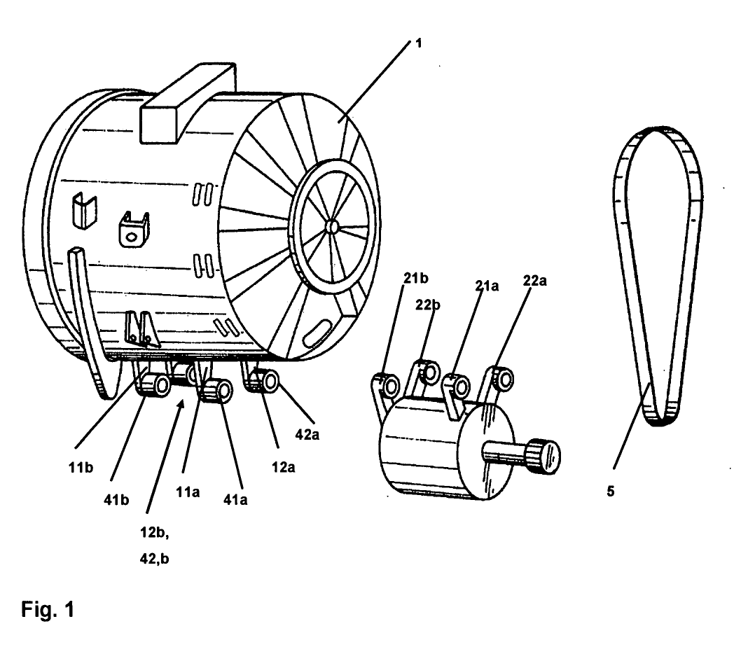

FIG. 1 shows an exploded view of a tub, a motor and a belt of a washing machine,

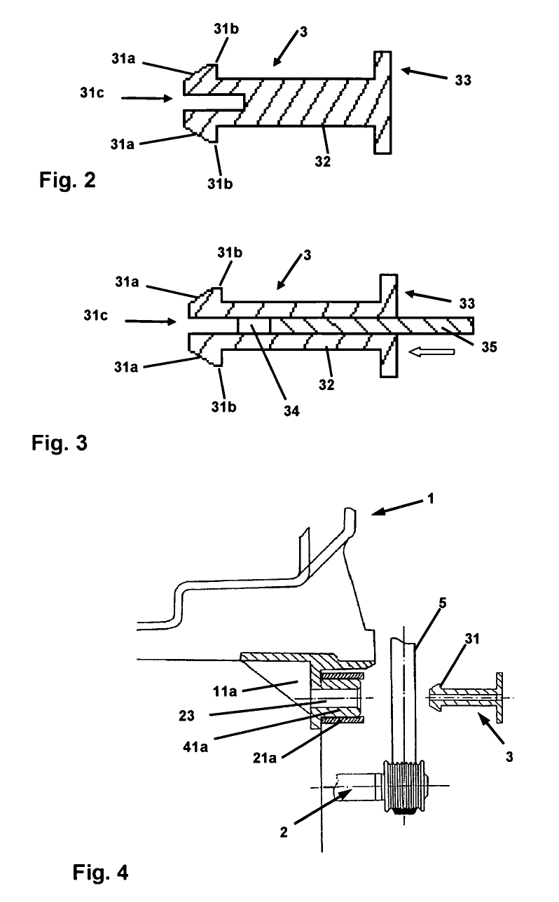

FIG. 2 shows a sectional view through a securing element of the mounting device according to a first exemplary embodiment,

FIG. 3 shows a sectional view through a securing element of a mounting device according to a second exemplary embodiment,

FIG. 4 shows a sectional view through a tub with the mounting device according to the first exemplary embodiment,

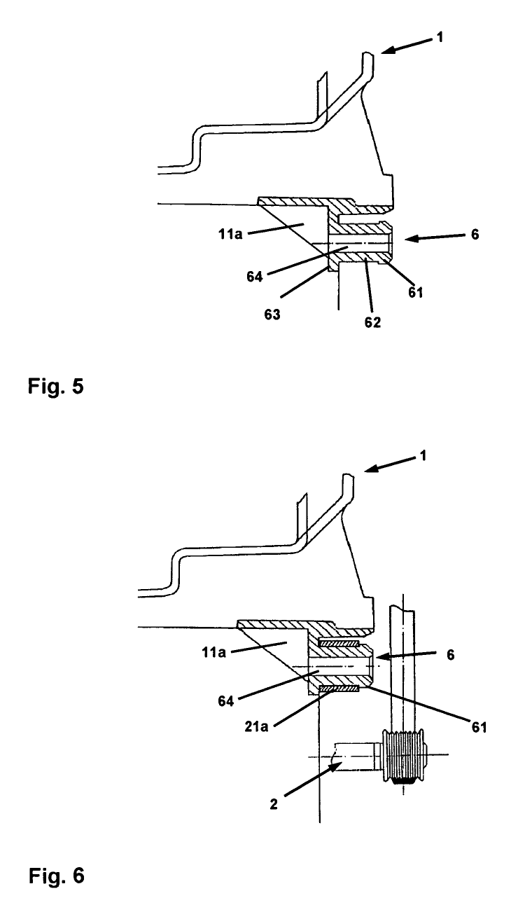

FIG. 5 shows a sectional view through a tub with a mounting device according to a third exemplary embodiment, and

FIG. 6 shows a further sectional view through a tub with the mounting device according to the third exemplary embodiment.

The same or functionally identical elements are labeled by the same reference signs in all the figures.

FIG. 1 shows an exploded view of a section of a household appliance for treating laundry items. In the exemplary embodiment said household appliance is embodied as a washing machine. It can, however, also be provided that the household appliance is embodied as a tumble dryer, for example. As can be seen in the schematic in FIG. 1, a tub 1 is embodied with a mounting device which is embodied for securing a motor 2 to or in the washing machine. It can, however, also be provided that the motor 2 is secured by means of the mounting device to some other arbitrary carrier device in the washing machine.

As the schematic in FIG. 1 shows, the motor 2 in the exemplary embodiment has connecting zones 21a, 21b, 22a and 22b. In the exemplary embodiment the mounting device has holding zones 11a, 11b, 12a and 12b. In the exemplary embodiment the holding zones 11a, 11b, 12a and 12b have the illustrated carrier elements 41a, 41b, 42a, 42b, which can be embodied as mounting studs, for example. In the exemplary embodiment shown, four holding and four connecting zones are depicted, though in alternative embodiments the motor 2 and the mounting device can have a different number of holding and connecting zones. At least two connecting zones are provided on the motor 2 for the functionally reliable and secure mounting of the motor 2.

The connecting zones 21a, 21b, 22a and 22b of the motor 2 are embodied in such a way that by means of said connecting zones 21a, 21b, 22a and 22b the motor 2 can be mechanically connected to the holding zones 11a, 11b, 12a and 12b. For that purpose the connecting zones 21a, 21b, 22a and 22b are slipped onto the carrier elements 41a, 41b, 42a and 42b of the holding zones 11a, 11b, 12a and 12b.

For the purpose of securing and arranging the motor 2 in a positionally stable manner, in a first exemplary embodiment shown in FIG. 4 the mounting device comprises at least one latching element 31 by means of which at least one mechanical connection between a connecting zone and the respective holding zone, between the connecting zone 21a and the holding zone 11a in the exemplary embodiment shown, is secured by means of the latching element 31. Toward that end, at least one securing element 3, shown in FIGS. 2, 3 and 4, is provided for the mounting device, said securing element 3 being embodied as a pin-like insertion element and integrally joined to the latching element 31 as a single piece. To provide a stable mechanical connection the securing element 3 is disposed in the area of the mechanical connection between a holding zone, for example 11a, and the connecting zone 21a associated with said holding zone. The securing element 3 is therein introduced into the insertion opening 23 shown. The further connecting zones 11b, 12a and 12b can also be mechanically connected to the respective holding zones 21b, 22a and 22b in an analogous manner.

The securing element 3 is inserted or introduced in such a way that it locks in place in an end position (not shown in the figure) and so can no longer release itself autonomously. The mechanical connection between the zones 11a and 21a or the mechanical connections between the zones 11b, 12a, 12b and 21b, 22a, 22b, if multiple securing elements 3 are included, can thus be fixed in a simple and reliable manner by means of the securing elements 3.

As can also be seen from the schematic in FIG. 1, what is termed a four-point connection is used between the motor 2 and the tub 1 in the exemplary embodiment. However, the holding and connecting zones can also be embodied in such a way that it suffices to provide only a two-point connection between the motor 2 and the tub 1 for mounting the motor 2. It can, however, also be provided that more than two mechanical connections of said kind are embodied.

In its installed location the motor 2 is disposed in a suspended position in the exemplary embodiment. The suspended position or, as the case may be, the suspension points are formed by means of the mechanical connections between the respective associated holding and connecting zones, for example 11a and 21a or 11b and 21b, etc. For the rest the motor 2 is disposed in an, as it were, free-floating manner.

As can also be seen from the schematic in FIG. 1, the motor 2 is coupled to a belt 5 which can be provided, for example, for driving a transmission or a drum or else also other elements of the washing machine. By means of the mounting device the motor 2 can be positioned in such a way that it is disposed in an optimal position with regard to the actuation of the belt 5. The belt 5 can thus turn in a manner which minimizes wear and enable an optimal transmission of the force generated by the motor.

FIG. 2 shows a sectional view of the securing element 3. As can be seen from the schematic in FIG. 2, the securing element 3 has a first end zone 31, a middle zone 32 adjoining the first end zone 31 and a second end zone 33 adjoining the latter. As can be seen, the first securing element 3 has a pin-like design.

The first end zone 31 is embodied as conical at its end 31a facing away from the middle zone 32. The conical zone 31a transitions into a stub-shaped area which in the exemplary embodiment is embodied as a partially circumferential ridge 31b. As can be seen, the ridge 31 b is embodied as wider than the middle zone 32. Owing to these different dimensions a sort of latching lug or lugs can be embodied by means of the ridge 31b, enabling the first securing element 3 to lock in place in the end position. The latching lug or lugs embody the latching element 31 in the first end zone 31 of the securing element 3. In this exemplary embodiment the first end zone 31 and the latching element 31 have the same longitudinal extension, which is why they are designated by means of the same sign However, the first end zone and the latching element can also have mutually different longitudinal extensions.

As can also be seen in FIG. 2, the securing element 3 is embodied as slotted, at least in the first end zone 31. In the exemplary embodiment shown, the slotted zone 31c also extends partially into the middle zone 32. As a result of this slotted embodiment, at least the first end zone 31 and a part of the middle zone 32 are separated from each other, thereby dividing at least the first end zone 31 into two by means of the slotted zone 31c. These two parts can then be moved relative to each other, in particular resiliently with respect to each other. In this way a simple introducing of the securing element 3 into a corresponding introduction zone 23, which is provided for connecting the holding and connecting zones, can be made possible.

The second end zone 33 is embodied in the manner of a nail head.

FIG. 3 shows a further sectional view of a securing element 3. In this embodiment, in contrast to the schematic shown in FIG. 2, the securing element 3 has a hollow channel 34 which is embodied in the middle zone 32 and in the second end zone 33. The hollow channel 34 or the drilled hole extends as far as the slotted zone 31c. As can be seen from the schematic shown in FIG. 3, a locking element 35 is partially inserted into said hollow channel 34. In the exemplary embodiment the locking element 35 has a length which is greater than the length of the securing element 3. In the exemplary embodiment the locking element 35 is embodied as a securing pin and in the fully inserted state extends from the outermost end of the first end zone 31 (left-hand edge in FIG. 3) to beyond the second end zone 33.

A further exemplary embodiment of the invention is shown in FIGS. 5 and 6. The figures show a section through the tub 1 of a washing machine at a holding zone 11a at which a pin-like carrier element 62 is attached. The latching element 61, which is embodied in the same way as the latching element 31 of the pin-like insertion element 3, is integrally joined to the carrier element 62 as a single piece. The carrier element 62 together with the latching element 61 forms a securing element 6 onto which the connecting element 21a can be inserted or slipped. The connecting element 21a and consequently also the motor 2 connected to the connecting element 21a are positioned locked in place with the thus embodied securing element 6 in its end position as shown in FIG. 6. The special advantage of this implementation is that for the purpose of the secure and reliable positioning of the motor 2 the carrier element 62 and the latching element 61 can be manufactured together with the tub 1 as a single component. In this case the components are advantageously implemented in plastic. Accordingly, no further elements are required for securing the motor 2 to the tub 1.

Alternatively the securing element 6, which consists of the latching element 61 and the carrier element 62, and/or the holding zone 11a can consist of metal, with the securing element 6 in the case of such an implementation being connected for example to the holding zone 11a by way of a bolted or latching connection or welded joint.

Only one holding zone 11a is shown in FIGS. 5 and 6, this being connected to a securing element 6. In the same way a securing element 6 of this kind can also be provided for a plurality of holding zones or for each holding zone.

In the implementation shown in FIGS. 5 and 6, the securing element 6, like the securing element 3, has a first end zone 61 which is embodied at least partially conically. Said first end zone 61 is embodied as wider at an end adjoining a middle zone 62 of the securing element 6 and has an at least partially circumferential ridge. Said ridge is embodied similarly to the ridge 31b of the securing element 3.

In addition, the securing element 6 can advantageously have a slot (not shown) at least in the area of the first end zone. The slotted area can also partially extend into the middle zone 62. Owing to this slotted embodiment, at least the first end zone 61 and a part of the middle zone 62 are separated from each other, as a result of which at least the first end zone 61 is divided into two by the slotted area. These two parts can then be moved relative to each other, in particular resiliently with respect to each other. In this way a simple introducing of a corresponding introduction zone of the connecting element 21a onto the securing element 6 can be made possible.

Analogously to the implementation of the securing element 3, in a further exemplary embodiment (not shown) a locking element can be introduced into the securing element 6 into a hollow channel 64 which is formed at least in the middle zone 62 and in the second end zone 63. The hollow channel 64 or the drilled hole extends as far as the slotted area. The locking element has a length which is greater than the length of the securing element 6. As in the exemplary embodiment of the securing element 3, the locking element is embodied as a securing pin and extends from the outermost end of the first end zone 61 to beyond the second end zone 63.

In the present exemplary embodiments the holding zones (11a, 11b, 12a, 12b) are disposed on a tub 1 of a washing machine. The invention is not limited to such an arrangement. The holding zones can also be disposed on other components of the household appliance, on a supporting housing component of a tumble dryer, for example.

1-15. (canceled)

16. A mounting device for a motor in a household appliance for treating laundry items, comprising:
at least two connecting members operatively associated with the motor;
at least two holding members operatively associated with the household appliance
wherein each connecting member is configured for mechanically connecting to a respective holding member; and
a latching element for operational association with a connecting member and the respective holding member to maintain at least one mechanical connection between the connecting member and the respective holding member.

17. The mounting device according to claim 16 and further comprising at least one securing element which is formed as a pin-like insertion element to which the latching element is integrally joined as a single piece.

18. The mounting device according to claim 17 wherein the pin-like insertion element is locked in place in an end position.

19. The mounting device according to claim 16 and further comprising at least one pin-like carrier element for connecting to a holding zone with the carrier element being integrally joined to the latching element as a single piece to form a securing element.

20. The mounting device according to claim 19 wherein the motor is locked in place at an end position thereof.

21. The mounting device according to one of claims 17 wherein the securing element has a first end portion formed in an at least a partially conical configuration.

22. The mounting device according to claim 21 wherein the first end portion includes a portion that extends laterally away from the middle portion of the securing element.

23. The mounting device according to claim 22 wherein the first end portion includes an at least partially circumferential ridge formed at an end which adjoins the middle zone of the securing element and extending laterally away therefrom.

24. The mounting device according to one of claims 21 wherein the securing element includes a slot formed to extend at least partially into the first end portion.

25. The mounting device according to claim 24 wherein the securing element has a hollow channel formed therein to extend at least over a length between a second end zone and the slot.

26. The mounting device according to claim 25 and further comprising a locking element for disposition in the hollow channel.

27. The mounting device according to claim 26 wherein the locking element is longer than the securing element.

28. The mounting device according to claim 16 wherein each holding portion includes has at least one carrier element configured for receipt of at least a portion of a holding portion.

29. The mounting device according to claim 16 wherein the holding portions are configured for mounting a motor in a suspended disposition.

30. A household appliance for treating laundry items formed as one of a washing machine and a tumble dryer, the household appliance comprising a motor and a mounting device which includes at least two connecting members operatively associated with the motor; at least two holding members operatively associated with the household appliance wherein each connecting member is configured for mechanically connecting to a respective holding member; and a latching element for operational association with a connecting member and the respective holding member to maintain at least one mechanical connection between the connecting member and the respective holding member
